(19) United States
(12) Patent Application Publication
(10) Pub. No.: US 2002/0174638 A1
(43) Pub. Date: Nov. 28, 2002

(54) Vehicle mounted self-leveling tool attachment

(75) Inventors: Trent Borgesen, Pine Island, MN (US); Anthony Delva, Pine Island, MN (US); Bruce Duncan, Millville, MN (US); Randall Utecht, Owatonna, MN (US)

Correspondence Address: OJANEN LAW OFFICES, LTD., 2665 RIVERSIDE LANE, NORTHEAST, ROCHESTER, MN, 55306-3456, US

(73) Assignee: BorgEZE Manufacturing, Mantorville, MN (US)

(21) Appl. No.: 09/865,408

(22) Filed: May 25, 2001

(51) Int. Cl. A01D 34/64; A01D 34/07; A01D 34/24

(52) U.S. Cl. 56/14.9; 56/15.2; 56/15.5; 56/17.1

(57) ABSTRACT

A tool head attachment is disclosed for use with a farm or other industrial equipment, such as a bobcat or a four-wheeler. Extending from a frame mounted on the vehicle or equipment is a beam attached to self-leveling mechanism. The beam meets at an angle on a rotatable assembly from which another beam extends. The rotatable assembly allows up to full rotation of one beam about the other beam for storage. At or near the rotatable assembly is a safety break away mechanism which causes the beams to separate when a major obstacle is encountered. The other beam extending from the rotatable assembly is attached to a self-articulating and self-leveling assembly to which a tool head is mounted. The self-articulating and self-leveling assembly maintains the tool head a relative distance from or into the surface of the ground and easily deflects upon encountering a minor obstacle without interruption of operation. Different tool heads may include tillers, harvesters, cutters, etc.

### TECHNICAL FIELD

This invention relates generally to the field of attaching tools to vehicles in general and more specifically relates to vehicle-mounted rotary blade and string cutters used for cutting vegetation that is self-leveling, self-articulating, and is able to move around and deflect from an obstacle without stopping the forward motion of the vehicle.

### BACKGROUND OF THE INVENTION

Some of the current attachable cutters in the industry employ a complex hydraulic control system to adjust the height and position of cutters, such as U.S. Pat. No. 3,949,539 entitled Hydraulic Mower Attachment to Cartner; U.S. Pat. No. 4,502,269 entitled Hydraulic Mower Head Orienting Apparatus for Boom Mowers to Cartner; U.S. Pat. No. 5,210,997 entitled Articulated Boom Tractor Mounted Cutter Assembly to Mountcastle, Jr.; and U.S. Pat. No. 5,396,754 entitled Tractor-Mounted Articulated Arm and Trimmer Attachment to Fraley. These hydraulic control systems must be manually operated by a human; typically, while also driving the tractor or the boom mower. Fraley '754 and a “No-Stop” Trimming Mower disclosed on page 12, of the FARM SHOW Magazine (1994) disclose two trimmers which present a present a spring-loaded cutter that deflects when the cutter encounters fixed obstructions. Again, however, Fraley '754 requires manual operation of complex hydraulic controls while driving the vehicle; and the “No-Stop” Trimming Mower is attached to the rear of the vehicle so the driver of the vehicle cannot see what is being cut or what obstacle there is to the cutter attachment.

What is lacking in the industry is a simple, self-leveling and self-articulating cutter attachment that can be attached to tractors and smaller vehicles such as BOBCATS and/or four wheelers and the like towards the front so that the operator of the vehicle can pay attention to the direction and to the cutting without having to manipulate hydraulic controls. What is further lacking is the ability to achieve different orientations with respect to the vehicle, including the ability to rotate the cutter around the vehicle for easy storing.

### SUMMARY OF THE INVENTION

These needs and others that will become apparent to one skilled in the art are satisfied by an apparatus for mounting a tool unto a vehicle, comprising: a frame for attachment to the vehicle; an attachment mechanism on the frame to attach to the frame to the vehicle; a vertical self-leveling assembly mounted on the frame; a vertical motion beam having one end attached to the vertical self-leveling assembly; a rotational assembly connected to another end of the vertical motion beam; a break away safety mechanism connected to the rotational assembly; a horizontal motion beam having one end connected to the rotational assembly, the rotational assembly allowing the vertical motion beam to rotate with respect to the horizontal motion beam; and a self-articulation retractable assembly connected to another end of the horizontal motion beam.

The apparatus may further comprise a tool removably connected to the self-articulation retractable assembly. The frame may be a mounting plate. The attachment mechanism may be selected from the group consisting of: a bracket assembly, a n-point hitch, a QUIKTACH assembly.

The vertical self leveling assembly may further comprise a vertical spring and/or a self-retractable cylinder. The break-away safety mechanism may be a shear bolt connecting each respective one of the vertical motion beam and the horizontal motion beam onto a sleeve of the rotational assembly. Alternatively, the break-away safety mechanism may be a weakened portion of the horizontal motion beam and/or the vertical motion beam.

The rotational assembly allows up to 360 degree rotation of the horizontal motion beam about the vertical motion beam. The self-articulation retractable assembly may further comprise a second self-retractable cylinder and/or spring connecting the horizontal motion beam with a plate extending from the self-articulation retractable assembly. The self-articulation retractable assembly may also further comprise a second self-retractable cylinder and/or spring extending between a rigid plate extending from the center of the rotational assembly to a second rigid plate extending from the center of the self-articulation retractable assembly on opposing sides of the self-articulation retractable assembly. The self-leveling mechanism may connect the removable tool head to self-articulation retractable assembly. The self-leveling mechanism may comprise at least one self-retractable cylinder and/or spring, or it may comprise at least two springs on opposite sides of the tool head connected to opposing sides of the self-articulation retractable assembly.

The apparatus may further comprise an adjustable support wheel through the center of the self-articulation assembly upon which the tool rides and upon adjustment, determines the height of the tool with respect to the ground surface.

The tool may be a cutter head having a cutting mechanism of at least one rotating cutting blade. The cutter head may have a cutting mechanism that is at least one string and/or cable cutter.

The apparatus may further comprise a power unit connected by a belt drive to provide power to the tool.

The invention may further be considered a brush cutter comprising: a mounting frame for attachment to a vehicle; an attachment mechanism on the frame to attach to the frame to the vehicle; a vertical self-leveling assembly comprising a vertical guide and a retractable cylinder and/or a spring adjacent to the vertical guide, the vertical self-leveling assembly mounted on the frame, to allow relatively free motion of the cutter in the vertical plane; a vertical motion beam having one end pivotally attached to the mounting frame and connected to the vertical self-leveling assembly such that the vertical motion beam extends outwardly from and moves freely within the vertical guide; a rotational assembly having a sleeve upon which the vertical motion beam; a shear bolt to position and set the vertical motion beam onto the sleeve; a horizontal motion beam situated on the rotational assembly, the rotational assembly allowing the horizontal motion beam to rotate with respect to the vertical motion beam upon removal of the shear bolt; a self-leveling and self-articulation retractable assembly comprising a plate connected to a retractable cylinder and/or at least one compressible spring, the plate connectable to the horizontal motion beam to allow rotation of the self-articulation retractable assembly away from the direction of travel and to provide tension to return the self-articulation retractable assembly to an original position; and a removable cutter connected to the self-leveling and self-articulation retractable assembly, the cutter being able to rotate during operation and follow the contour of the land during forward motion because of the self-leveling and self-articulation retractable assembly.

The invention may also be considered an attachable farm implement, comprising: means to attach the farm implement to a vehicle; means to extend a first beam of the farm implement away from the vehicle; means to vertically level the farm implement; means to rotate the farm implement about a first vertical axis; means to break away the farm implement at or near the first vertical axis; means to attach a tool head to the farm implement attachment; means to maintain a relative distance between the tool head and a surface of the ground; means to balance the tool head when in use; and means deflect the tool head when encountering a minor obstacle during use.

### BRIEF DESCRIPTION OF THE DRAWING

The novel features believed characteristic of the invention are set forth in the claims. The invention itself, however, as well as a preferred mode of use, objects and advantages thereof, will best be understood by reference to the following detailed description of an illustrative embodiment when read in conjunction with the accompanying Drawing, wherein:

FIG. 1 is a front elevation view of a vehicle-mountable cutter in an extended position in accordance with one embodiment of the invention.

FIG. 2 is a plan view of the vehicle-mountable cutter in the extended position of FIG. 1.

FIG. 3 is an exploded view of the rotational assembly of the cutter in accordance with an embodiment of the invention.

FIG. 4 is an exploded view of the self-articulating assembly of the cutter in accordance with one embodiment of the invention.

FIG. 5 is a perspective view of the extended cutter mounted on a vehicle in accordance with an embodiment of the invention.

FIG. 6 is a front elevation view of a vehicle mounted cutter in accordance with a different embodiment of the invention.

FIG. 7 is a plan view of the alternative embodiment of the invention.

### DETAILED DESCRIPTION OF THE INVENTION

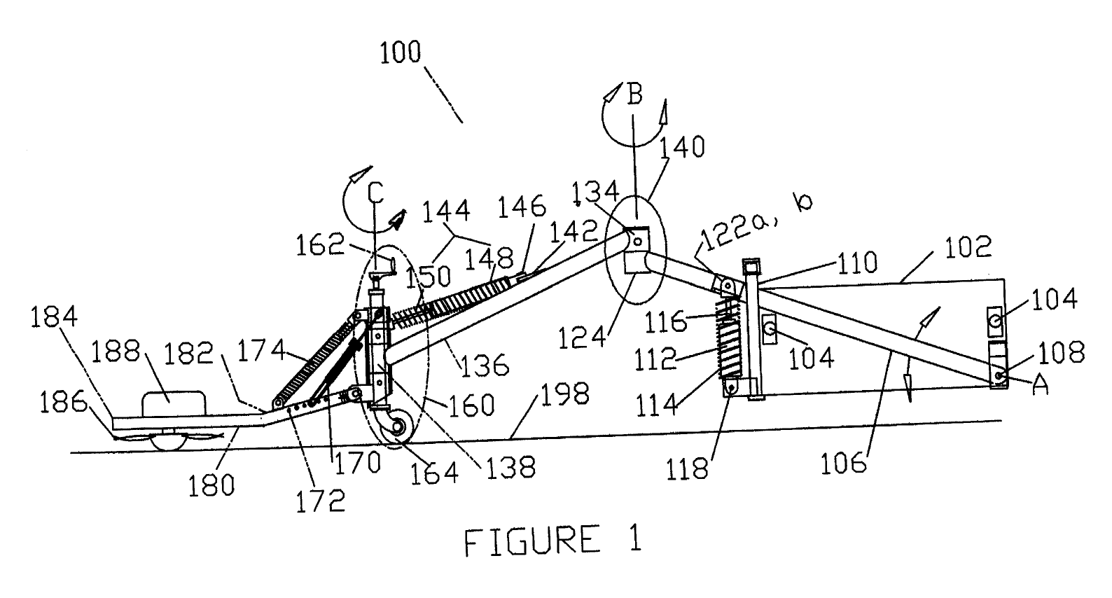

Referring to the Drawing, wherein like numbers denote like parts throughout the several views, FIG. 1 is a front view of a vehicle-mountable tool attachment 100, consistent with an embodiment of the invention. The tool attachment 100 is self-articulating, self-leveling, and self-balancing so that the driver of the vehicle on which the tool attachment and tool are mounted need pay attention only to the motion of the vehicle and need not manually control the cutter during operation. The tool attachment 100 is constructed from rigid material, such as metal square or round tubing. The tool attachment 100 could also be manufactured from high density plastic, perhaps implemented steel or other metal reinforcements at the attachment or mounting locations. Although the embodiment illustrated is mounted on the front of a BOBCAT, the tool attachment may be manufactured to fit other vehicles often used in agricultural and/or industrial locations, such as a four-wheeler, a tractor, etc., and may be mounted on the side or the rear of the vehicle. Preferably, the material from which the tool attachment is manufactured is rigid and rust-resistant or rust-proof. A mounting plate 102 mounts on the vehicle (not shown), preferably with bolts or locking pins or other common mechanical mounting devices 104 for industrial mechanical equipment, such as a universal BOBCAT attachment, a Quiktach, a bracket assembly, or skid loader. Mounting plate 102 preferably extends across the front of the vehicle and is preferably mounted across the front in several locations for stability of the tool attachment and the vehicle during use. Appropriate adjustments may have to be made to the vehicle if the tool attachment is mounted on the sides or the rear of the vehicle.

Viewing the mounting plate 102 as mounted on the front of a vehicle for purposes of describing dimensions, a rigid transverse beam 106 is pivotally mounted onto the mounting plate 102 towards one edge at a pivot point A 108; although shown here as being mounted near the bottom right edge of the mounting plate 102, another embodiment will show the transverse beam 106 as being mounted towards the top of the mounting plate 102. The transverse beam 106 extends across the mounting plate 102 in a diagonal direction towards the upper left edge of the mounting plate 102. The transverse beam 106 is slidably mounted in a vertical guide 110. Because the motion of the traverse beam 106 is only in a vertical plane parallel to the mounting plate 102, it shall henceforth be referred to as the vertical motion beam 106. Vertical guide 110 is mounted on the mounting plate 102 extending a sufficient distance from the surface of the mounting plate 102 to accommodate free motion of the vertical motion beam 106 within the guide 110. Vertical guide 110 permits limited vertical motion of the vertical motion beam 106 which pivots in a vertical plane parallel to the face of mounting plate 102 at point A 108.

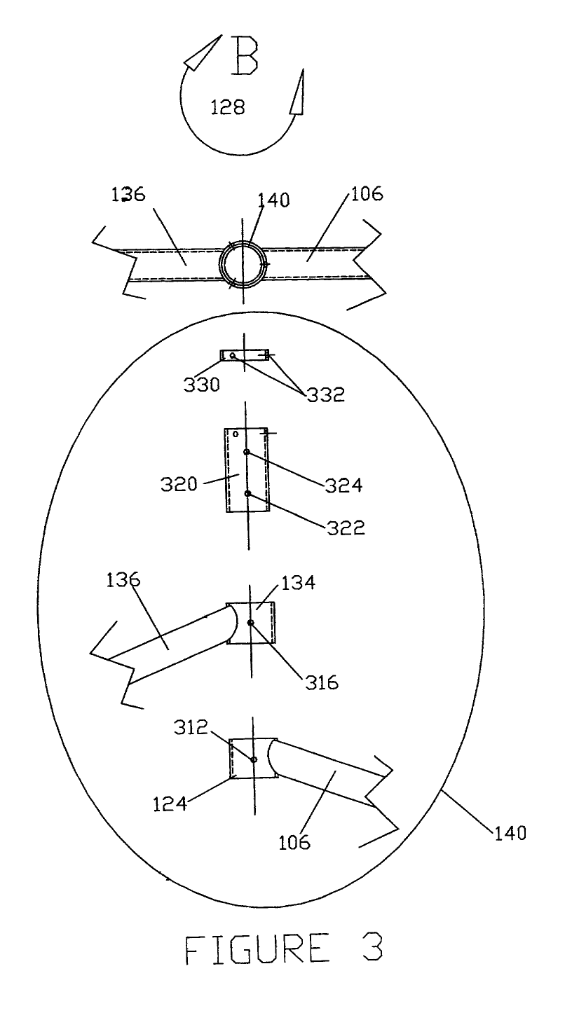

Adjacent to the vertical guide 110 is a vertical self-leveling assembly 112. The bottom of a vertical self-leveling assembly 112 is mounted on the vertical guide 110 and/or the mounting plate 102 with a bolt mechanism 118, such as a clevis or other attachment. The vertical self-leveling assembly 112 may comprise a spring 114 and/or a hydraulic or pneumatic self-retractable cylinder 116, such as a shock absorber, mounted within the spring 114. The top of the vertical self-leveling assembly 112 is fixed to the face of the vertical motion beam 106 using clevis plates 122a and 122b (not shown). Alternatively, the vertical self-leveling assembly 112 could also be bolted, welded or otherwise fixedly attached to the vertical motion beam 106. The vertical motion beam 106 terminates in a hollow cylinder 124 at the rotational assembly 140. The rotational assembly 140 will be described in greater detail with respect to FIG. 3.

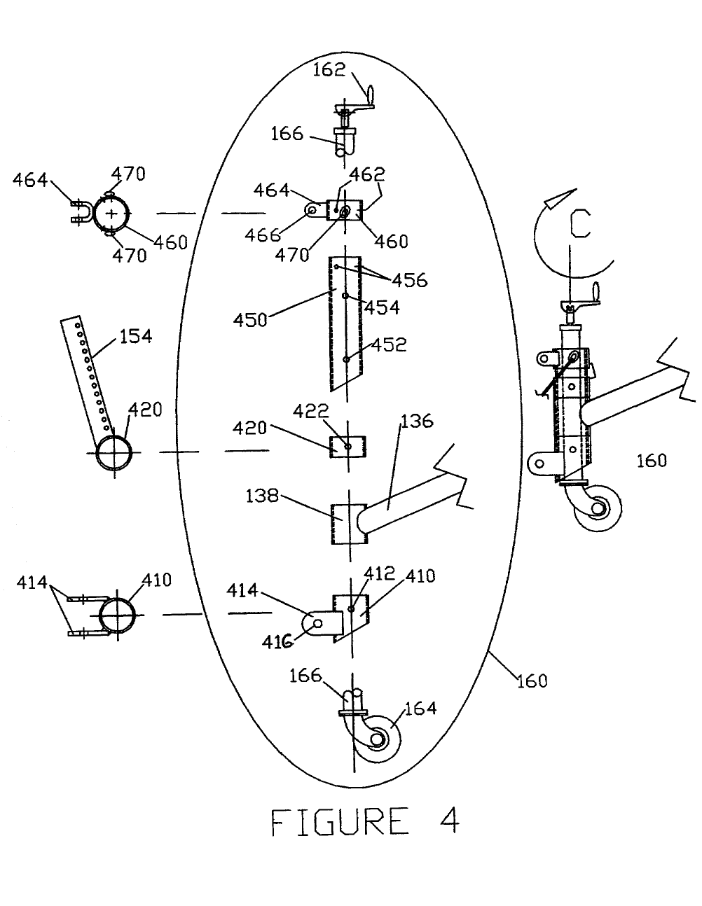

A second beam 136 connecting to the rotational assembly 140 will be referred to as the horizontal motion beam 136 because it permits rotation of the tool attachment 100 in a horizontal plane, that is, a plane relative to the ground or other surface 198. At one end, the horizontal motion beam 136 has a terminating cylinder 134 which can be mounted onto the rotational assembly 140. The horizontal motion beam 136 extends at an obtuse angle with respect to the vertical motion beam 106. Horizontal motion beam 136 terminates at the other end in a second terminating cylinder 138 that is mounted on a self-articulating assembly 160. The self-articulating assembly 160 will be described in more detail with respect to FIG. 4.

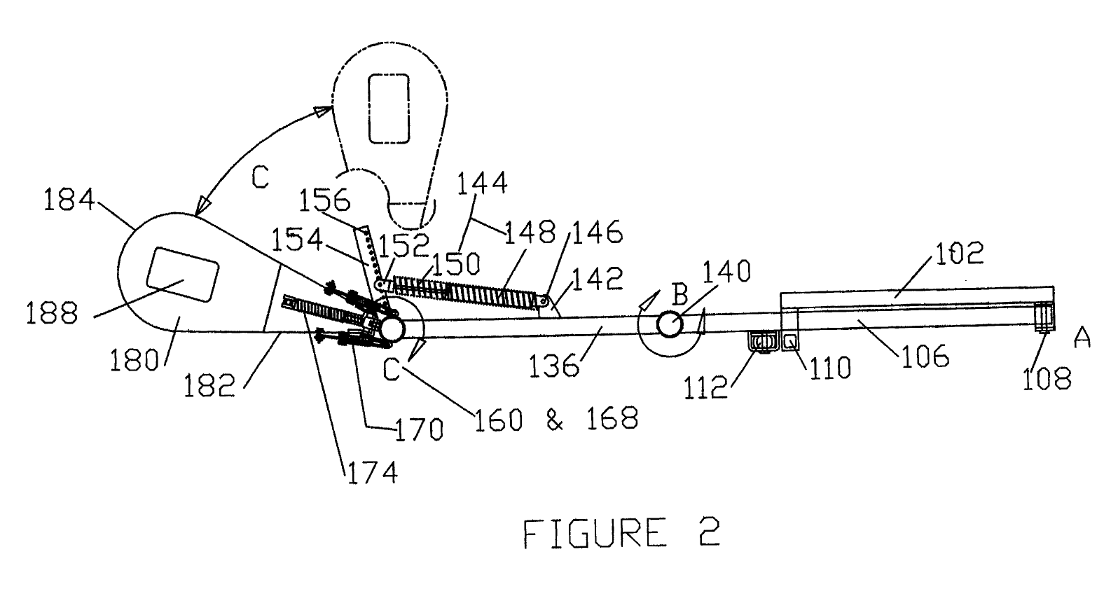

Attached to the horizontal motion beam 136 is the horizontal return tension assembly 144 which will now be described in greater detail with regard to FIG. 2. On the back side of the horizontal motion beam 136 is a mounting plate 142 to which the horizontal return tension assembly 144 is attached by a clevis assembly 146. The horizontal return tension assembly 144 may comprise a spring 148 and/or a pneumatic or hydraulic self-retractable cylinder 150. A mounting plate or clevis assembly 152 at the other end of the horizontal return tension assembly 144 connects to a plate 154. Plate 154 has a number of holes 156 in which the mounting plate 154 of the horizontal return tension assembly 144 is mounted. When the horizontal return tension assembly 144 is mounted at a hole 156 that is proximate to the self-articulation assembly 160, the return tension on the spring 148 or self-retractable cylinder 150 is less than when the horizontal return tension assembly 144 is mounted at a hole 156 distal to the self articulation assembly 160. The tension established by mounting the horizontal return tension assembly 144 onto the plate 154 determines how easily the tool head 180 will rotationally deflect around point C 162 when a fixed obstacle is encountered, as will be discussed when describing the rotational motion of a cutting head 180.

Returning to FIG. 1 in conjunction with FIG. 2, the self-articulation assembly 160 is that portion of the tool attachment 100 which is self-leveling and follows the contour of the cutting surface 198 at assumed ground level. The self-articulation assembly 160 permits rotation of the tool head 180 around point C 168 to automatically deflect upon encountering obstacles, such as trees or fence posts during operation. The self articulation assembly 160 also connects the horizontal return tension assembly 144 and the tool head 180. The self-articulation assembly 160 generally comprises a hollow metal cylinder around which connecting portions of the tool head 180 and the horizontal return tension assembly 144 are attached. A swivel wheel 164 supports the self-articulation assembly 160 and establishes the distance at which the tool rides or floats above or in the ground surface, as for example, the cutting height of the cutter head 180. The wheel 164 is connected through the hollow cylinder of the self-articulation assembly 160 to a crank handle 162 to adjust the height of the self-articulation assembly from the ground or other surface 198. In turn, that height will influence the tool height of the tool head 180.

Also connected to the self-articulation assembly 160 are balancing springs 170 mounted onto the tool head 180 through holes 172 on the proximate end 182 of the tool head 180. FIG. 2 shows that there are two balancing springs 170 which help to control the roll and pitch of the tool head 180 during operation. Depending upon the size and weight of the tool head 180, an optional tool head spring/self-retractable cylinder assembly 174 may also be connected to the self-articulation assembly 160 and mounted, preferably towards the center of gravity of the tool head 180 to further control the motion of the tool head 180 during operation as the tool head follows the contour of the cutting surface 198.

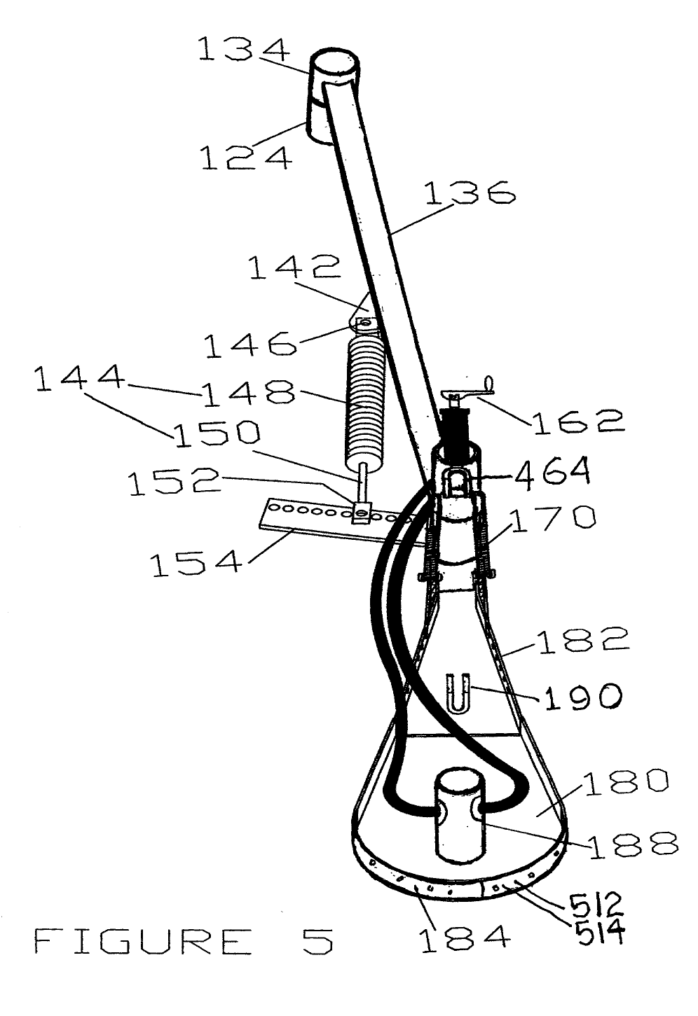

With respect to FIG. 1, when the tool head 180 is a cutter head, the cutter head 180 has a proximate end 182 towards and a distal end 184 away from the self-articulation assembly 160, respectively. Cutter head 180 will be discussed in greater detail with respect to FIG. 5, but the cutter head 180 has rotatable blades 186 and a power unit 188 to provide power to the blades 186.

FIG. 3 is an enlarged view of the rotational assembly 140. The rotational assembly 140 actually comprises mechanical and structural parts of the terminating portions 124, 134 of the vertical motion beam 106 and the horizontal motion beam 136, respectively, connected together so that the beams may rotate independently about a center axis B 128. Preferably these terminating portions 124, 134 are integral with their respective beams and are circular in inner and outer circumferences. Each terminating portion 124, 134, has at least one hole 312, 316, respectively, through the diameter for placement of shear bolts or other locking mechanisms. The terminating portions 124 and 134 fit onto a sleeve 320 which also has holes 322 and 324 along its diameter for alignment and locking of the terminating portions 124 and 134, respectively using shear bolts (not shown). Although one alignment hole is shown in the figures, one of skill in the art will appreciate that more than one alignment hole placed around the circumference with a corresponding hole through the diameter of the terminating portions will facilitate different angles of the tool head 180 with respect to the vehicle for various geometries. The rotational assembly 140 is fixed into its vertical arrangement with a collar 330 and set screws/bolts 332 onto the top and/or bottom of the sleeve 320. The rotational assembly 140 permits up to 360° rotation of the horizontal motion beam 136 about the center vertical axis of the terminating cylinder 124 of the vertical motion beam 106 when the shear bolt 129 or other locking mechanism is removed.

The use of the shear bolts provides an important break away safety feature of the tool attachment 100 which is also very economical. When a large obstacle or a large hole is encountered or another event which places significant torque onto the vertical and/or horizontal motion beams 106, 136, respectively, the shear bolt will break allowing rotation of one beam about the other. This break away safety feature is important because it protects the more expensive structure of the beams from bending or breaking, as well as preventing the vehicle and the operator from tipping over or otherwise becoming unstable when such an obstacle is encountered or event occurs. The use of the shear bolt is the preferred embodiment of the break away safety feature; other implementation may include intentionally weakening the structural beams 106, 136 at strategic locations which allow them to break easily when such an extreme event occurs.

The rotational assembly 140 illustrated in FIG. 3 is only one embodiment. Alternatively, the terminating cylinder 124 of the vertical motion beam 106 could have a lower portion with a larger outer diameter and an integral upper portion of a smaller outer diameter with alignment holes upon which the terminating cylinder 134 of the horizontal motion beam 136 could be rotatably mounted. Rotation could be permitted using an oil or grease or silicon between the inner diameter of the terminating portions 134 (and 124) and the outer diameter of the sleeve 320 (or the upper portion of terminating cylinder 124) or a sealed ball bearing mechanism could be implemented to permit rotation. The full circular rotation allowed by the rotational assembly 140 allows the horizontal motion beam 136 to be rotated in front of the vertical motion beam 106 and the vehicle for storage or other geometries for cutting. Yet in another embodiment, rotational assembly 140 may comprise a heavy spring or other self-retraction assembly similar to that described in FIG. 4.

FIG. 4 is an exploded view of the self-articulating assembly 160. The self-articulating assembly connects the cutter head 180 to the tool attachment. Basically, the self-articulating assembly 160 may be structured on a hollow sleeve 450 about which the connecting portions are mounted. The support wheel 162 is attached to a shaft 166 extending through the interior of the sleeve 450; mounted on the top of shaft 166 is the crank handle 162 to adjust the height of the self-articulating assembly 160 with respect to the surface 198. The bottom collar 410 to be mounted on the outer circumference of the sleeve 450 has a pin or bolt hole 412 for alignment onto a hole 452 of the sleeve 450. Attached to the bottom collar 410 is a mounting plate or clevis 414 having a hole 416 for attachment of the cutter head 180. On top of the bottom collar 410 is the terminating portion 138 of the horizontal motion beam 136 which is also slidably mounted onto the circumference of the sleeve 450. Above the terminating portion 138 is a metal band 420 to surround the sleeve 450; metal band 420 having a mounting hole 422 to align with the mounting hole 454 of the sleeve 450 so that its position may be fixed with a pin or bolt. The metal band 420 provides a spacer for the extension of the horizontal motion beam 136 and also provides a connection for plate 154. Plate 154 is fixedly connected by welding or bolting onto the metal band 420 and extends in the horizontal plane at an angle greater than ninety degrees from the horizontal motion beam 136. Mounted on the outer diameter of the top of the sleeve 450 is a top collar 460. Top collar also has an alignment hole 462 to mate with alignment hole 456 of the sleeve 450. Preferably, there is a mounting plate or a clevis assembly 464 with a hole 466 for connection to the tool head spring and/or self-retractable cylinder assembly 174. On opposite sides of a diameter of the top collar 460 are two U-shaped connections 470 for connecting the balancing springs 170 to the self-articulation assembly 160.

FIG. 5 is a perspective of the tool attachment 100 from the perspective of looking towards the tool head 180. One of skill in the art will appreciate the benefits of the invention as a cutter, however, tools other than a cutter head 180 may be attached to the self-articulating assembly 160. Examples of other such tools may include a plow, a vacuum, a spreader, a seeder, etc. An important concept is that the tool be able to either float at a relatively constant height above or a relatively constant depth within the land while performing its function, and if it were to hit an obstacle, to be able to deflect and return to its original position without damaging the tool. The tool will herein be referred to as a cutter but is not limited to the cutting function; similarly the cutter head will also encompass other tool functions.

As can be seen in FIG. 5, the cutter head 180 attaches to and extends from the self-articulating assembly 160 at a slight angle from a straight angle with respect to the horizontal motion beam 136. This slight angle facilitates movement of the cutter head 180 and deflection of the object when the cutter head 180 strikes a fixed object during operation. The cutter head 180 is a pie-shaped metal with a rounded apex towards its proximate end 182 and attaches through the mounting plate/clevis assembly 414 of the bottom collar 410 (not shown in FIG. 5) of the self-articulating assembly 160. Again, other attachable tool heads will have other geometries to accommodate the function of the tool. Balancing springs 170 are attached to the perimeter of the proximate end 182 and extend upwardly towards and attach to the self-articulating assembly 160. The proximate end 182 extends upward at an angle from the cutting surface 198 whereas the distal end 184 of the cutter head 180 is almost parallel to the cutting surface 198. This slight angle adds additional flexibility to the motion of the cutter head 180. It will be appreciated, however, that the cutter head 180 need not be angled in this fashion but could be flat. The distal end 184 is intended to float parallel to the surface 198 with the balancing springs 170 to control the roll of the cutter head 180. If used, the tool head spring and/or self-retractable cylinder assembly 174 can attach to clevis assembly 464 and to a mounting plate or other clevis assembly 190 on the tool head 180. The distal end 184 curves in a semicircular arc to accommodate the rotating cutter blades mounted underneath. Rotating cutter blades are but one implementation of the cutting mechanism; other options include string cutters, metal, plastic, cable blades, strings, etc. The cutter head 180 has a lip or phlange 512 to which a strip 514 of Teflon or other material may be attached to facilitate deflection and provide protection for the cutter head 180. The cutter head 180 also has a power unit 188 to mount and provide power to the cutting blades underneath.

Shown in FIG. 5 is a hydraulic-controlled power box 188, although other power mechanisms, such as a diesel or gasoline powered mower can be mounted onto the cutter head 108. The power box 188 may have the capability for adjustable speeds or rpms of the cutter blades/strings. The power box 188 may be directly attached to the blades of the cutter head 108 by means of a rotating shaft, or the blades of the cutter could be belt driven. When belt driven, the cutter head 108 could be streamlined such that the power box 188 could be displaced from cutting blades. Safety and protection of the power box 188 also improves using belt drives. The height of the cutter head 108 above the surface of the earth 198 is determined by the wheel 164 (not shown) and the extension of the wheel shaft 166 (not shown).

During operation, as the vehicle moves in a forward direction, the tool head 180 rides along the surface of the earth 198 supported by the wheel 164. Balancing springs 170 and the tool head spring/self-retraction cylinder assembly 174, if used for the heavier and larger tool heads 180, provide further support and allow the cutter head to float. The tool attachment assembly 100 when used with a cutter as a tool 180 is especially useful for cutting along fence lines and when a fence post or a tree is encountered, the cutter head 180 is deflected backwards from the direction of motion.

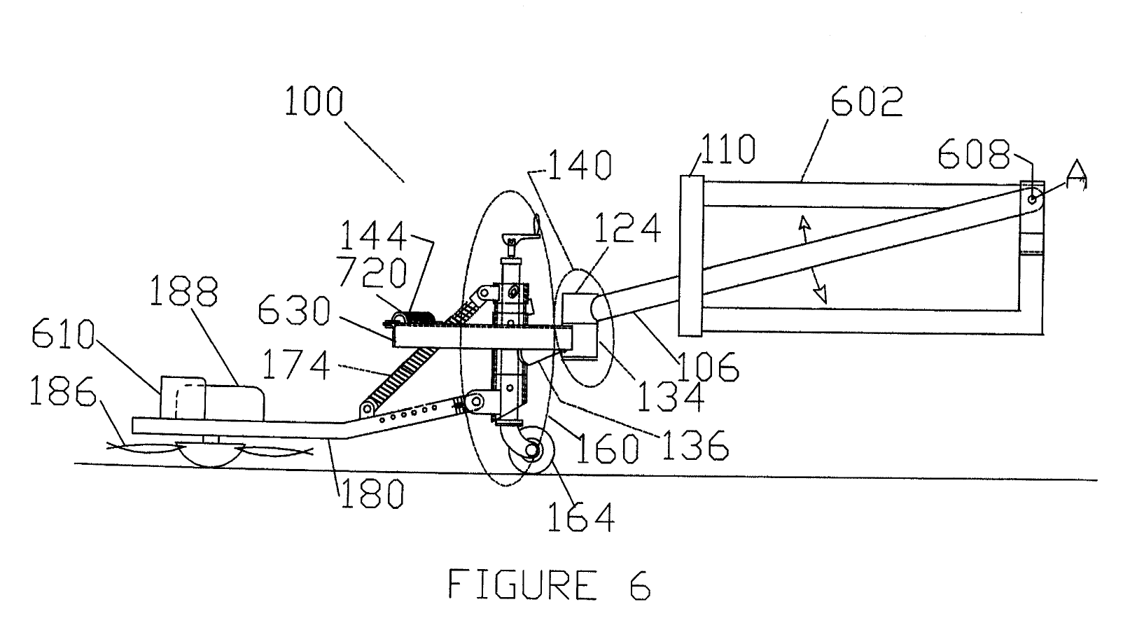

FIG. 6 is another embodiment of the tool attachment 100 that could be mounted onto an alternative vehicle, such as a four wheeler. As can be seen in the figure, the mounting plate of FIG. 1 has been replaced with a mounting frame 602. Shown here as rectangular in shape and manufactured from steel pipes or rectangular bars, the mounting frame 602 need not be rectangular but it is intended to be within the scope and spirit of the invention that the mounting frame 602 be of any shape and material sufficient to securely and stably mount the tool attachment 100 on a vehicle. Indeed, a mounting plate 102 was shown in FIG. 1 and could be used on a four wheeler or another vehicle as well.

Attached to the mounting frame 602 at a pivot point A 608 is the vertical motion beam 106. Note that the vertical motion beam 106 extends downward and across the front of the vehicle (not shown) and can move up and down within a vertical guide 110. The vertical guide 110 has previously been described with respect to FIGS. 1 and 2. At the end of the vertical motion beam 136 opposite from the pivot point A 608 is the terminating cylinder 124 which is mounted onto the rotational assembly 140. The rotational assembly 140 has been described with respect to FIG. 3 except that the terminating cylinder 124 of the vertical motion beam 106 is above, rather than below, a termination portion of the connecting beam.

The rotational assembly 140 not only connects the terminating cylinder 124 of the vertical motion beam 106, it also connects the terminating portion 134 of the horizontal motion beam 136. In this embodiment the horizontal motion beam 136 is much shorter and serves as a spacer between the rotational assembly 140 and the self-articulation assembly 160. Attached to the rotational assembly 140 and integral with or otherwise fixedly mounted to the terminating portion 134 of the horizontal motion beam 136 is also a second horizontal return tension bar 630.

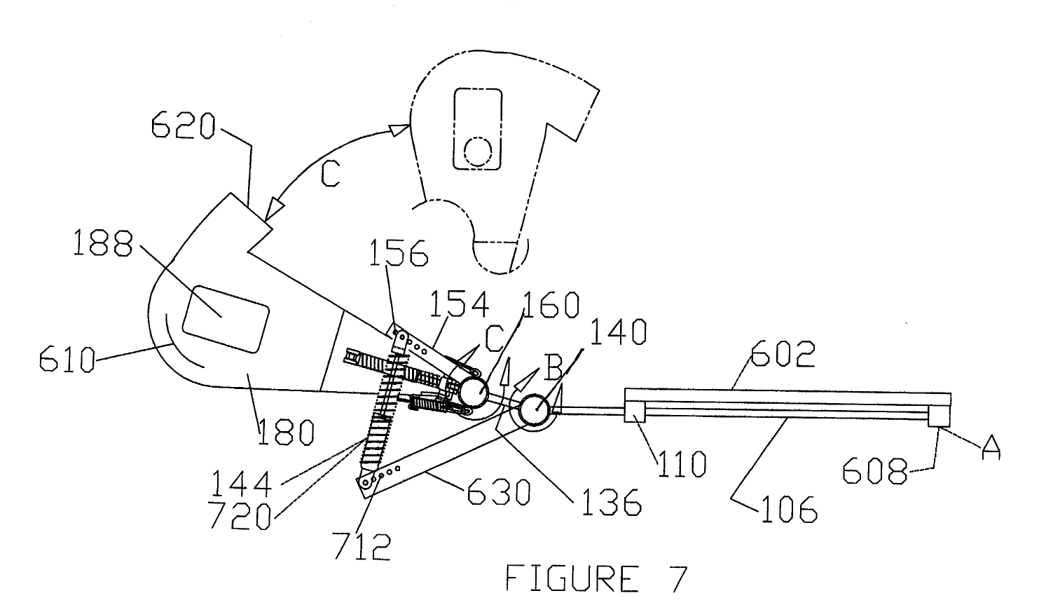

Viewing FIGS. 6 and 7 together in which the plan view of the self-articulation assembly 160 can be seen in FIG. 7, the self-articulation assembly 160 in this embodiment is slightly different than the self-articulation assembly 160 of FIG. 4, but maintains the same function and same basic features. One difference is the inclusion of the horizontal return tension bar 630 having holes 712 extending from the rotational assembly 140 and integral with or otherwise fixed to the terminating portion 134 of the horizontal motion beam 134. Note that the horizontal return tension assembly 144 is now mounted using clevis attachments or other attachments to one of a plurality of holes 712, 156 of both the horizontal return tension bar 630 and the mounting plate 154, respectively. An optional chain 720, not seen because it may be hidden underneath the horizontal return tension assembly 144 or other rigid or flexible connecting member can connect the tension bar 630 and the mounting plate 154. Other components and equivalents of the tool attachment 100 are described with respect to the previous figures.

Shown in FIGS. 6 and 7 is a shield 610 which can be an upright piece of metal or screen or other protective shield to protect the power box 188 and/or other components of the tool head 180 from flying debris or obstacles, etc. Shield 610 is a feature which can be implemented on any embodiment. A directional exhaust 620 can also be implemented on alternative embodiments to direct the debris and mulch to a specific direction, including to a removable attached bag (not shown) for removal of the debris or even harvest of the cut foliage.

While various embodiments of the present invention have been described above, it should be understood that they have been presented by way of example and not limitation and that variations are possible. Thus, the breadth and scope of the present invention should not be limited by any of the above-described exemplary embodiments, but should be defined only in accordance with the following claims and their equivalents.

What is claimed is:

1. An apparatus for mounting a tool unto a vehicle, comprising:
(a) a frame for attachment to the vehicle;
(b) an attachment mechanism on the frame to attach to the frame to the vehicle;
(c) a vertical self-leveling assembly mounted on the frame;
(d) a vertical motion beam having one end attached to the vertical self-leveling assembly;
(e) a rotational assembly connected to another end of the vertical motion beam;
(f) a break away safety mechanism connected to the rotational assembly;
(g) a horizontal motion beam having one end connected to the rotational assembly, the rotational assembly allowing the vertical motion beam to rotate with respect to the horizontal motion beam; and
(h) a self-articulation retractable assembly connected to another end of the horizontal motion beam.

2. The apparatus of claim 1, further comprising a tool removably connected to the self-articulation retractable assembly.

3. The apparatus of claim 1, wherein the frame further comprises a mounting plate.

4. The apparatus of claim 1, wherein the attachment mechanism further is selected from the group consisting of: a bracket assembly, a n-point hitch, a QUIKTACH assembly.

5. The apparatus of claim 1, wherein the vertical self leveling assembly further comprises a vertical spring and/or a self-retractable cylinder.

6. The apparatus of claim 1, wherein the break-away safety mechanism is a shear bolt connecting each respective one of the vertical motion beam and the horizontal motion beam onto a sleeve of the rotational assembly.

7. The apparatus of claim 1, wherein the break-away safety mechanism is a weakened portion of the horizontal motion beam and/or the vertical motion beam.

8. The apparatus of claim 1, wherein the rotational assembly allows up to 360 degree rotation of the horizontal motion beam about the vertical motion beam.

9. The apparatus of claim 1, wherein the self-articulation retractable assembly further comprises a second self-retractable cylinder and/or spring connecting the horizontal motion beam with a plate extending from the self-articulation retractable assembly.

10. The apparatus of claim 1, wherein the self-articulation retractable assembly further comprises a second self-retractable cylinder and/or spring extending between a rigid plate extending from the center of the rotational assembly to a second rigid plate extending from the center of the self-articulation retractable assembly on opposing sides of the self-articulation retractable assembly.

11. The apparatus of claim 1, further comprising a self-leveling mechanism connecting the removable tool head to self-articulation retractable assembly.

12. The apparatus of claim 10, wherein the self-leveling mechanism comprises at least one self-retractable cylinder and/or spring.

13. The apparatus of claim 10, wherein the self-leveling mechanism comprises at least two springs on opposite sides of the tool head connected to opposing sides of the self-articulation retractable assembly.

14. The apparatus of claim 1, further comprising an adjustable support wheel through the center of the self-articulation assembly upon which the tool rides and upon adjustment, determines the height of the tool with respect to the ground surface.

15. The apparatus of claim 2, wherein the tool is a cutter head having a cutting mechanism of at least one rotating cutting blade.

16. The apparatus of claim 2, wherein the tool is a cutter head having a cutting mechanism that is at least one string and/or cable cutter.

17. The apparatus of claim 2, further comprising a power unit connected by a belt drive to provide power to the tool.

18. A cutter comprising:
(a) a mounting frame for attachment to a vehicle;
(b) an attachment mechanism on the frame to attach to the frame to the vehicle;
(c) a vertical self-leveling assembly comprising a vertical guide and a retractable cylinder and/or a spring adjacent to the vertical guide, the vertical self-leveling assembly mounted on the frame, to allow relatively free motion of the cutter in the vertical plane;
(d) a vertical motion beam having one end pivotally attached to the mounting frame and connected to the vertical self-leveling assembly such that the vertical motion beam extends outwardly from and moves freely within the vertical guide;
(e) a rotational assembly having a sleeve upon which the vertical motion beam;
(f) a shear bolt to position and set the vertical motion beam onto the sleeve;
(g) a horizontal motion beam situated on the rotational assembly, the rotational assembly allowing the horizontal motion beam to rotate with respect to the vertical motion beam upon removal of the shear bolt;
(h) a self-leveling and self-articulation retractable assembly comprising a plate connected to a retractable cylinder and/or at least one compressible spring, the plate connectable to the horizontal motion beam to allow rotation of the self-articulation retractable assembly away from the direction of travel and to provide tension to return the self-articulation retractable assembly to an original position; and
(i) a removable cutter connected to the self-leveling and self-articulation retractable assembly, the cutter being able to rotate during operation and follow the contour of the land during forward motion because of the self-leveling and self-articulation retractable assembly.

19. An attachable farm implement, comprising:
(a) means to attach the farm implement to a vehicle;
(b) means to extend a first beam of the farm implement away from the vehicle;
(c) means to vertically level the farm implement;
(d) means to rotate the farm implement about a first vertical axis;
(e) means to break away the farm implement at or near the first vertical axis;
(f) means to attach a tool head to the farm implement attachment;
(g) means to maintain a relative distance between the tool head and a surface of the ground;
(h) means to balance the tool head when in use; and
(i) means deflect the tool head when encountering a minor obstacle during use.
